(19) United States
(12) Patent Application Publication
(10) Pub. No.: US 2010/0007186 A1
(43) Pub. Date: Jan. 14, 2010

(54) TENSION INDICATOR

(76) Inventors: L. Curtis Strong, Rock Hill, SC (US); Eugene R. Balensiefer, II, Tipton, IN (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/388,594

(22) Filed: Feb. 19, 2009

Related U.S. Application Data
(60) Provisional application No. 61/080,503, filed on Jul. 14, 2008.

(51) Int. Cl. A47D 1/10; G08B 21/00; B60N 2/26

(52) U.S. Cl. 297/250.1; 340/668

(57) ABSTRACT

A tension indicator for alerting a user when a predetermined tension has been applied to a flexible elongate element is provided. The tension indicator includes a housing having at least one opening for receiving the elongate element, a tension responsive element positioned in the housing in cooperative engagement with the elongate element and including an actuator mounted in the housing and engaging the elongate element, the tension responsive element being movable in response to an increase in tension on the elongate element from a normally inoperative position into an operative alert position, and an alert element cooperating with the tension responsive element for providing an alert when the tension responsive element is in the operative alert position.

### PRIORITY CLAIM

This application claims priority to U.S. Provisional Patent Application No. 61/080,503 filed on Jul. 14, 2008.

### TECHNICAL FIELD AND BACKGROUND OF THE INVENTION

This invention relates to a tension indicator of the type used to alert a user when a predetermined tension has been applied to an elongate element. One illustrative application is in combination with the harness of a vehicle child safety seat. While the invention is explained in relation to a child safety seat, it has broader application, as is apparent throughout this application.

Child safety seats are now legally mandated according to specified age and weight criteria. Such seats are typically installed in an either forward or rearward-facing direction on a vehicle seat, for example, the rear seat of an automobile. The seat itself may be attached by being restrained by the vehicle seat belt, or may be attached to connection points behind the vehicle seats, typically referred to as “Isofix” latches or connectors.

The child is restrained in the seat by a harness that typically passes between the legs of the child, up the torso and across the top of the shoulders. The harness extends through slots in the seat back and connects with a single tension strap located in the front of the seat bottom. The strap passes through a one-way latch that permits the tension strap to be pulled in the tension direction, but that normally restrains movement in the opposite direction. Tensioning the strap tightens the harness against the torso of the child. The strap is loosened by first releasing the latch from engagement with the strap.

The user is responsible for adjusting the strap to the proper tension, yet in prior art devices this is a matter of judgment. In some cases, the harness may be tightened too much, causing discomfort to the child in the seat. In other instances, the harness may be tightened too little, reducing the protection offered to the child by the safety seat.

Thus, a simple, easy-to-use device for permitting the harness tension on a child safety seat to be adjusted properly so that the tension is neither too loose nor too tight would provide enhanced safety to the seat occupant.

### SUMMARY OF THE INVENTION

Therefore, it is an object of the invention to provide a tension indicator of the type used to alert a user when a predetermined tension has been applied to an elongate element, such as a tension strap of the harness of a vehicle child safety seat.

It is another object of the invention to provide a tension indicator of the type used to alert a user when a predetermined tension has been applied to a harness strap of a vehicle child safety seat.

It is another object of the invention to provide a tension indicator of the type that permits a user to properly adjust the tension of a harness strap of a child safety seat in a manner that enhances both comfort and safety of the seat occupant.

These and other objects and advantages of the invention are disclosed below in connection with a tension indicator for alerting a user when a predetermined tension has been applied to a flexible elongate element. The tension indicator includes a housing having at least one opening for receiving the elongate element, a tension responsive element positioned in the housing in cooperative engagement with the elongate element and including an actuator mounted in the housing and engaging the elongate element, the tension responsive element being movable in response to an increase in tension on the elongate element from a normally inoperative position into an operative alert position, and an alert element cooperating with the tension responsive element for providing an alert when the tension responsive element is in the operative alert position.

In accordance with one embodiment of the invention, the actuator comprises a contact member carried by a retention pin attached to the housing and the elongate element is adapted to engage the retention pin and deform a free end of the contact member proportionately to the tension in the elongate element to a point where the free end of the contact member comes into contact with a sensor in communication with the alert element for providing an alert to the user.

In accordance with another embodiment of the invention, the sensor comprises an audible spring closely spaced from the contact member.

In accordance with another embodiment of the invention, the sensor comprises an electrical switch in electrical communication with an electronic indicator.

In accordance with another embodiment of the invention, the electronic indicator is a vibration device.

In accordance with another embodiment of the invention, the electronic indicator is a light emitting device.

In accordance with another embodiment of the invention, the electronic indicator is a sound emitting device.

In accordance with another embodiment of the invention, when the tension on the elongate element is below the predetermined tension, the elongate element is urged by the retention pin into a non-linear configuration, and when the tension on the elongate element is at or above the predetermined tension, the elongate element urges the retention pin to deform the free end of the contact member until the contact member contacts the sensor and provides an alert.

In accordance with another preferred embodiment of the invention, a child safety seat of the type having a harness for restraining a seat occupant that is tension adjustable by means of a tension strap connected to the harness is provided. The child safety seat has an improvement including a tension indicator for alerting a user when a predetermined tension has been applied to a flexible elongate element. The tension indicator includes a housing having at least one opening for receiving the elongate element. A tension responsive element is positioned in the housing in cooperative engagement with the elongate element and includes an actuator mounted in the housing and engaging the elongate element, wherein the tension responsive element is movable in response to an increase in tension on the elongate element from a normally inoperative position into an operative alert position. An alert element is provided and cooperates with the tension responsive element for providing an alert when the tension responsive element is in the operative alert position.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a front elevation of a child safety seat of the type incorporating a tension indicator according to one preferred embodiment of the invention;

FIG. 2A is a cross-sectional view of a tension indicator in a relaxed state according to one preferred embodiment of the invention;

FIG. 2B is a cross-sectional view of a tension indicator in a tensioned state according to one preferred embodiment of the invention;

FIG. 3 is a perspective view of the tension indicator in a relaxed state according to one preferred embodiment of the invention;

FIG. 4 is an exploded perspective view of the tension indicator according to one preferred embodiment of the invention;

FIG. 5 is an exploded partial perspective view of the tension indicator according to one preferred embodiment of the invention;

FIG. 6 is a perspective view of the tension indicator in a tensioned state according to one preferred embodiment of the invention;

FIG. 7A is a cross-sectional view of a tension indicator incorporating a signal light in a relaxed stated according to another preferred embodiment of the invention;

FIG. 7B is a cross-sectional view of a tension indicator incorporating a signal light in a tensioned stated according to another preferred embodiment of the invention;

FIG. 8A is a cross-sectional view of a tension indicator incorporating an electronic musical signal in a relaxed stated according to another preferred embodiment of the invention;

FIG. 8B is a cross-sectional view of a tension indicator incorporating an electronic musical signal in a tensioned stated according to another preferred embodiment of the invention;

FIG. 9A is a cross-sectional view of a tension indicator incorporating a vibratory signal in a relaxed stated according to another preferred embodiment of the invention; and

FIG. 9B is a cross-sectional view of a tension indicator incorporating a vibratory signal in a tensioned stated according to another preferred embodiment of the invention.

### DESCRIPTION OF THE PREFERRED EMBODIMENT AND BEST MODE

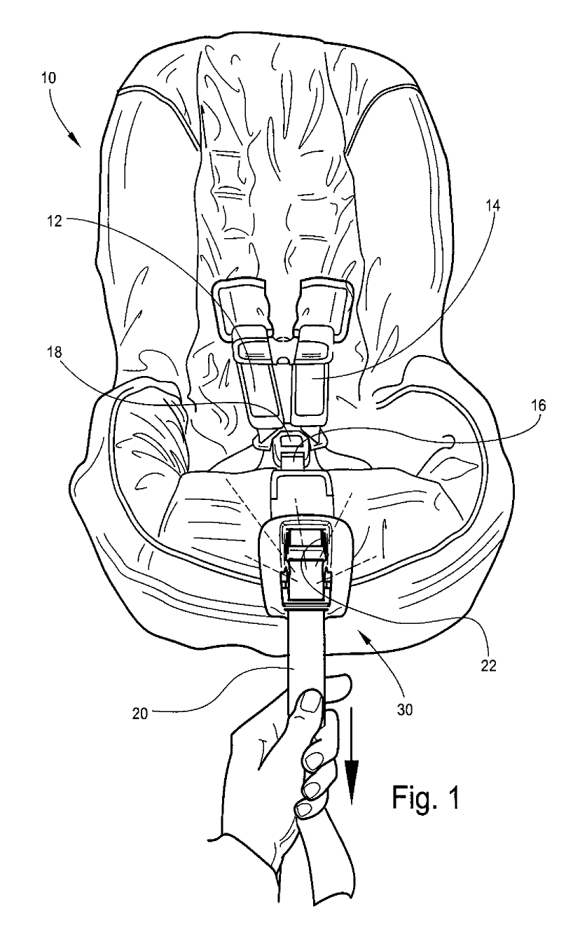

Referring now specifically to the drawings, a child safety seat 10 including a tension indicator 30 according to one embodiment of the invention is illustrated in FIG. 1. The seat 10 is conventional and is not otherwise described in detail. The seat 10 includes shoulder harness straps 12, 14 and a crotch strap 16 that are releasably connected to a harness latch 18. An elongate element, preferably tension strap 20, extends under the seat 10, connects to the shoulder harness straps 12, 14 behind the seat back, and exits through an opening 22. The tension strap 20 passes through a one-way latch 24, sometimes referred to as an “A-lok”. The latch 24 has teeth 26 that engage and tighten against the tension strap 20 as it is urged upwardly or outwardly in the “loosening” direction. The latch 24 permits the tension strap 20 to be pulled in the tensioning direction, but normally restrains movement in the opposite “loosening” direction. Tensioning the tension strap 20 tightens the shoulder harness straps 12, 14, and crotch strap 16 against the torso of the child.

The tension indicator 30 is preferably integrally-formed into the housing 32 of the latch 24. The tension indicator 30 may alternatively be affixed to a particular location on the tension strap 20, or may be positioned for sliding movement on the tension strap 20, or in some other location, including the underside of the seat 10. In some embodiments, the tension strap 20 may be in communication with the crotch strap 16. The tension indicator is in communication with an alert element that is configured to notify an operator that a predetermined amount of tension has been reached.

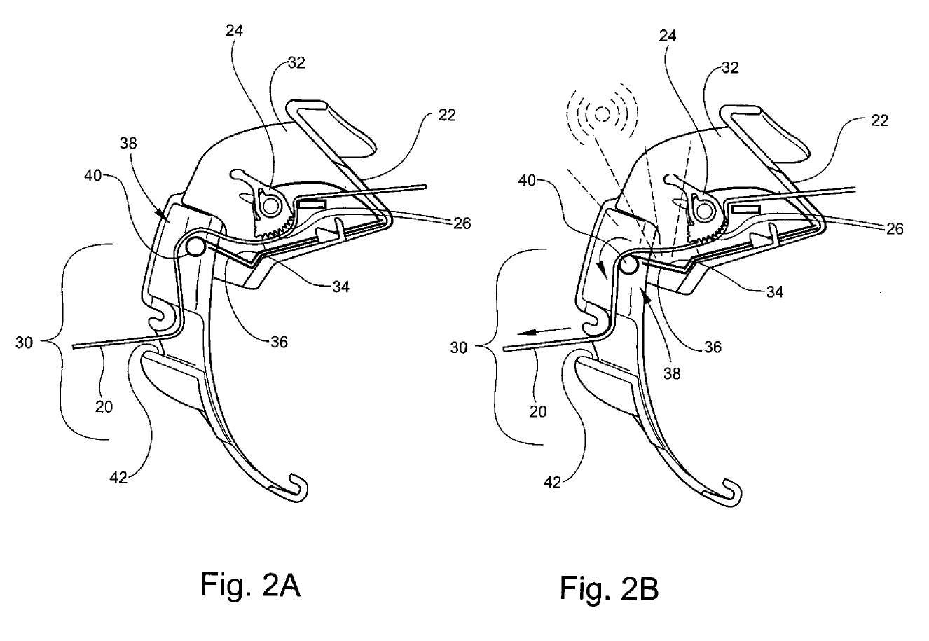

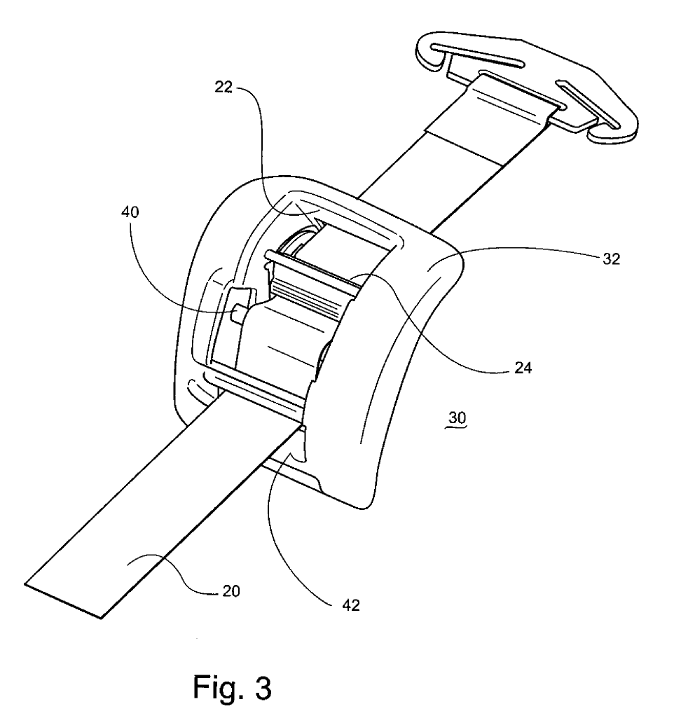

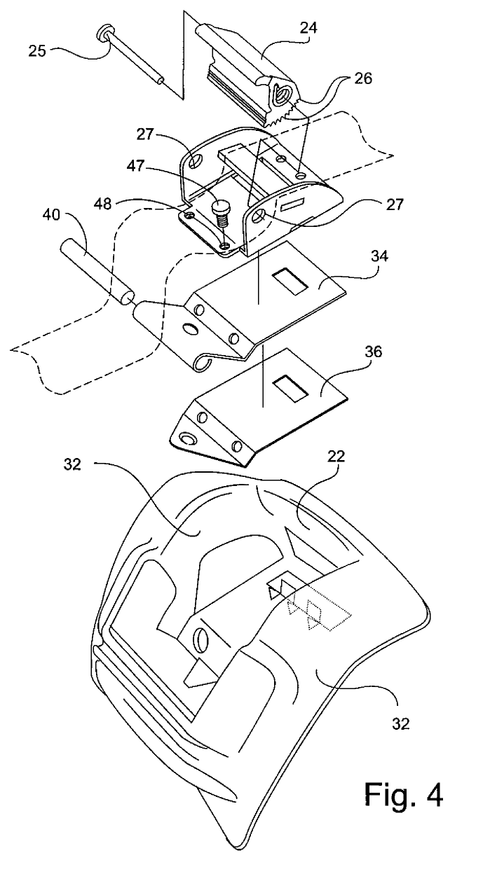

Referring now particularly to FIGS. 2A, 2B, and 3-5, one embodiment of the tension indicator 30 is shown and described. In the particular embodiment shown, the alert element is an audible alert, and a tension responsive element is formed of a contact member, in this embodiment, force spring 34 and a sensor, in this embodiment, a closely-spaced audible spring 36, cooperatively forming an actuator. The audible spring 36 is formed of a metal plate, sometimes referred to as an “oil can”, that is shaped such that when it is deformed, it makes a characteristic metallic “click” characteristic of the bottom of an oil can, or the well-known metal clickers of the type operated by being depressed between the thumb and forefinger.

The force spring 34 includes an annular retention element 38 that carries a retention pin 40 around which the tension strap 20 passes. The tension strap 20 exits the tension indicator 30 through an opening 42. As is best shown in FIG. 2A, the tension strap 20 normally assumes a sinuous shape as is passes under the latch 24, over the pin 40 and force spring 34, and then through the opening 42. The position of the opening 42 correctly positions the tension strap 20 so that when it is pulled, its tends to straighten, bearing downwardly against the force spring carried on the pin 40. Downward movement of the pin 40 under the force applied by pulling the tension strap 20 deforms the force spring 34 in the direction of the audible spring 36.

When the tension strap 20 has been tensioned to a predetermined degree, the force spring 34 engages and deforms the audible spring 36, causing the audible spring 36 to “click” in a manner characteristic of a metal clicker, providing an audible signal to the user that the tension on the harness straps 12, 14 and the crotch strap 16 is now proper and that the user should cease pulling on the tension strap 20. The latch 24 maintains the tension strap 20 in the properly tensioned position. Tension is released in the normal manner when desired by lifting the latch 24, causing the teeth 26 on the bottom of the latch to disengage from the surface of the tension strap 20.

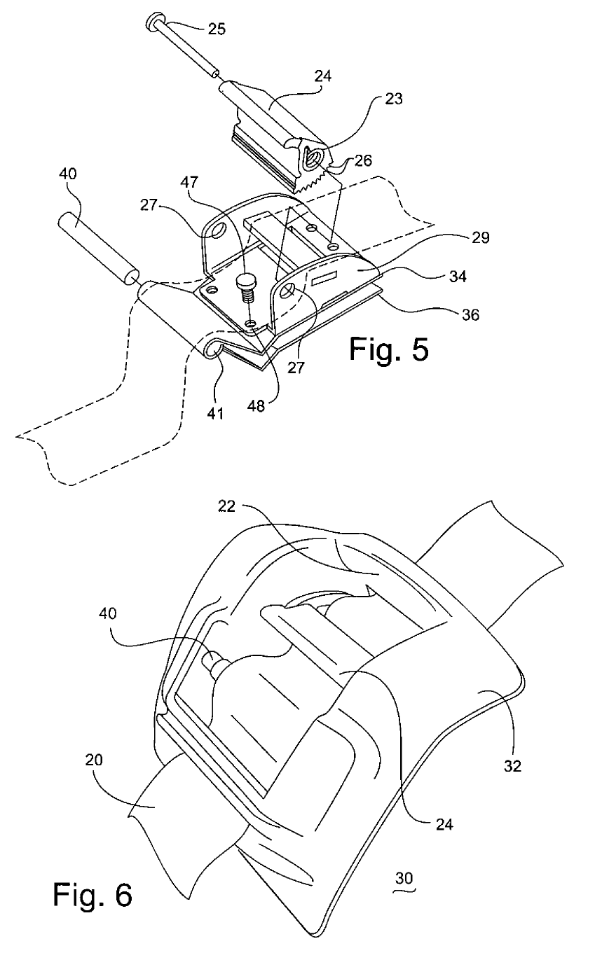

As best shown in FIGS. 5 and 6, latch 24 has an arcuate sliced section and the plurality of teeth 26 are positioned on the downward facing surface of the latch 24. A pin 25 is adapted to be received within an opening 23 of the latch 24 and fit within a corresponding and complementary opening 27 formed in the housing 29 of the latch 24. A fastener 47 may be provided for fastening the housing 29 to the force spring 34 together in a spaced apart relationship. The fastener 47 may be received in a complementary void 48. Pin 40 is provided in a complementary void 41 for securing the housing 29 to the tension indicator 30.

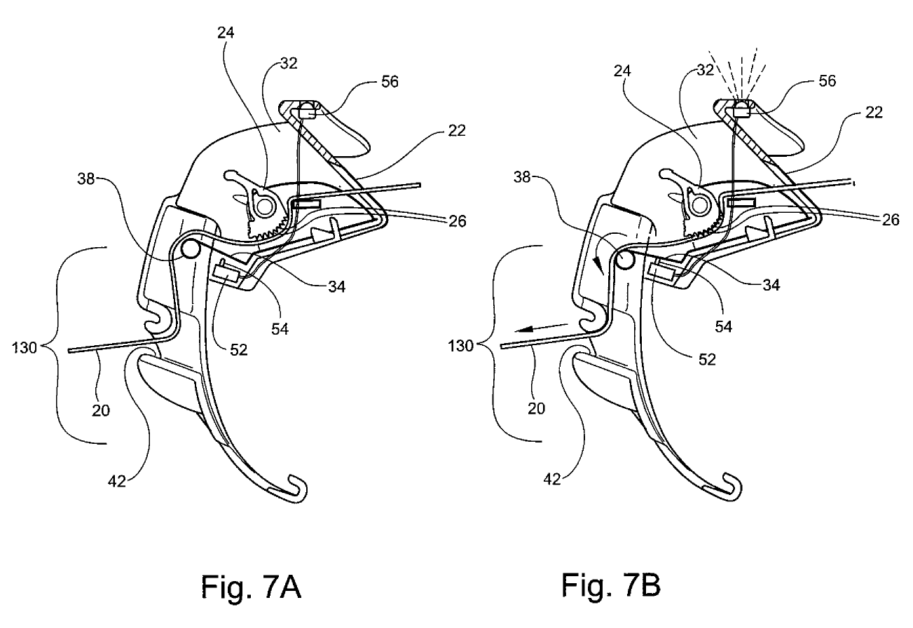

Referring to FIGS. 7A and 7B, a tension indicator 130 is shown, where elements in common with the tension indicator 30 are indicated by like reference numerals. The tension indicator 130 includes a sensor, which in this embodiment, includes a small electrically-powered switch 52 having a button 54 which, when depressed by the contact member 34, closes a circuit in the switch 52 and transmits electricity to an alert element, in this embodiment a, small light 56, such as an LED. The switch 52 preferably includes a timer so that the light 56 is “on” for only the amount of time, for example, a few seconds, necessary to alert the user that the correct tension has been achieved. Of course, in this embodiment the plate 34 need not be a “clicker”, and can be any device, metal or otherwise, that will return to the position shown in FIGS. 7A and 7B when tension on the tension strap 20 is released. The switch 52 is a conventional printed circuit board supporting an integrated circuit providing a timing function and a control for the light 56. The printed circuit board also preferably supports a momentary switch. The electrically-powered switch 52 is preferably powered by a small battery (not shown) contained within or adjacent to the switch 52, but in other applications the power may be furnished by connecting the switch 52 to the vehicle electrical system. In the embodiment shown in FIGS. 7A and 7B, only contact member 34 is shown, that in appropriate circumstances, the tension indicator 130 can be combined with an audible spring as described in regards to tension indicator 30 shown in FIGS. 1-6.

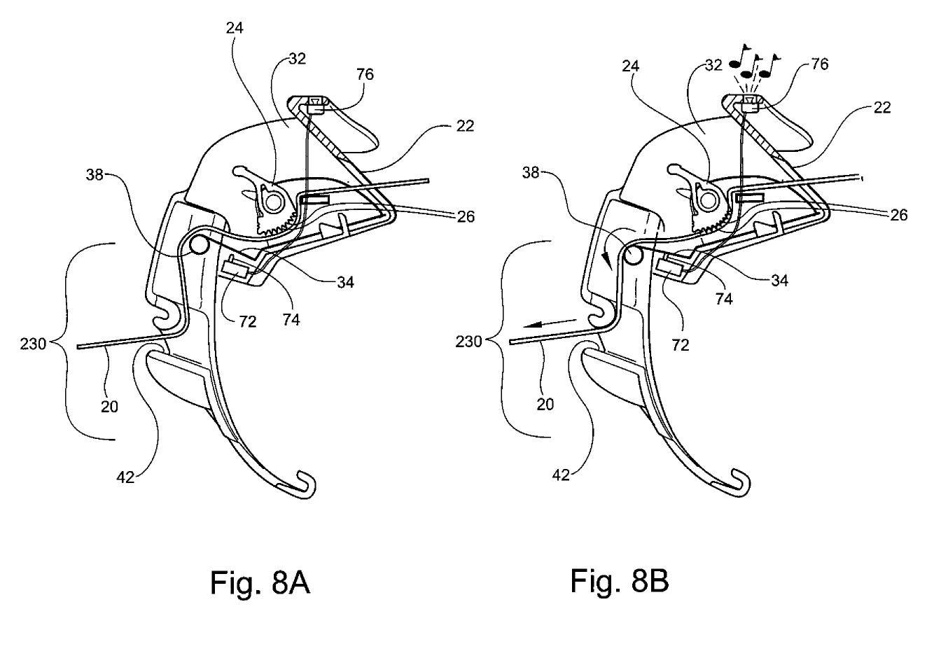

Referring to FIGS. 8A and 8B, a tension indicator 230 is shown, where elements in common with the tension indicator 30 are indicated by like reference numerals. The tension indicator 230 includes a sensor, which in this embodiment is a small electrically-powered switch 72 having a button 74 which, when depressed by the contact member 34, closes a circuit in the switch 72 and transmits electricity to an alert element, in this embodiment, a small sound emitting device 76, such as a piezo-electric sounding device or battery-powered sound emitter. The switch 72 preferably includes a timer so that the sound emitting device 76 is “on” for only the amount of time, for example, a few seconds, necessary to alert the user that the correct tension has been achieved. As noted above, in this embodiment the contact member 34 need not be a “clicker”, and can be any device, metal or otherwise, that will return to the position shown in FIG. 8A when tension on the tension strap 20 is released. In the embodiment shown in FIGS. 8A and 8B, only contact member 34 is shown, that in appropriate circumstances, the tension indicator 130 can be combined with an audible spring as described in regards to tension indicator 30 shown in FIGS. 1-6.

The switch 52 is a conventional printed circuit board supporting an integrated circuit providing a timing function and a control for the light 56. The printed circuit board also preferably supports a momentary switch. The electrically-powered switch 72 is preferably powered by a small battery (not shown) contained within or adjacent to the switch 52 or a piezo-electric device, but in other applications the power may be furnished by connecting the switch 72 to the vehicle electrical system.

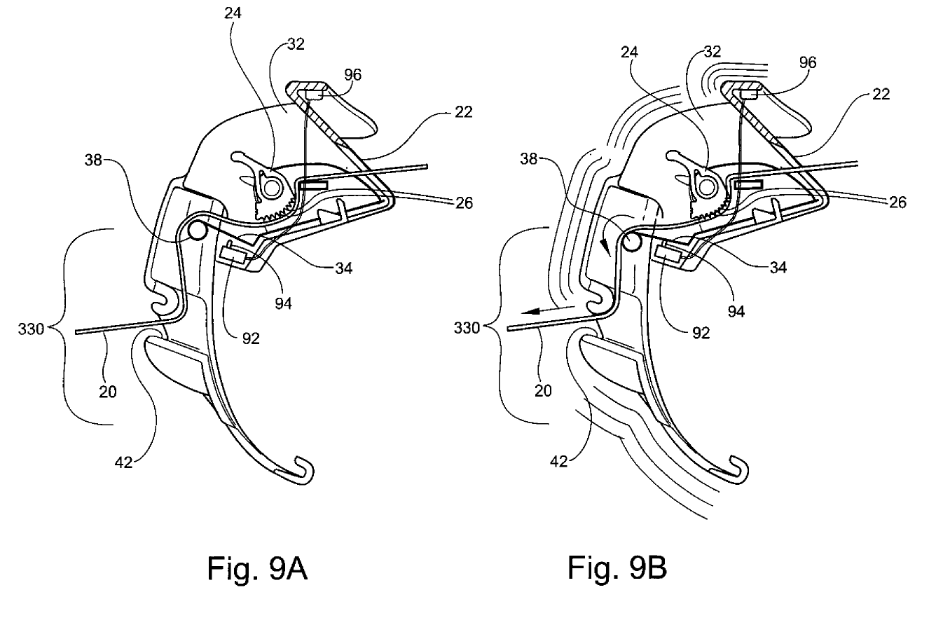

Referring to FIGS. 9A and 9B, a tension indicator 330 is shown, where elements in common with the tension indicator 30 are indicated by like reference numerals. The tension indicator 330 includes a sensor including a small electrically-powered switch 92 having a button 94 which, when depressed by the force spring 34, closes a circuit in the switch 92 and transmits electricity to a small vibrator 96, such as a small electric motor having an eccentric weight mounted on the rotor. The switch 92 preferably includes a timer so that the sound emitting device 96 is “on” for only the amount of time, for example, a few seconds, necessary to alert the user that the correct tension has been achieved. As noted above, in this embodiment the force spring 34 need not be a “clicker”, and can be any device, metal or otherwise, that will return to the position shown in FIG. 9A when tension on the tension strap 20 is released.

The switch 92 is a conventional printed circuit board supporting an integrated circuit providing a timing function and a control for the motor 96. The printed circuit board also preferably supports a momentary switch. The electrically-powered switch 92 is preferably powered by a small battery (not shown) contained within or adjacent to the switch 92, but in other applications the power may be furnished by connecting the switch 92 to the vehicle electrical system.

An tension indicator is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A tension indicator for alerting a user when a predetermined tension has been applied to a flexible elongate element, comprising:
(a) a housing having at least one opening for receiving the elongate element;
(b) a tension responsive element positioned in the housing in cooperative engagement with the elongate element and including an actuator mounted in the housing and engaging the elongate element;
(c) the tension responsive element being movable in response to an increase in tension on the elongate element from a normally inoperative position into an operative alert position; and
(d) an alert element cooperating with the tension responsive element for providing an alert when the tension responsive element is in the operative alert position.

2. A tension indicator according to claim 1, wherein the actuator comprises a contact member carried by a retention pin attached to the housing and the elongate element is adapted to engage the retention pin and deform a free end of the contact member proportionately to the tension in the elongate element to a point where the free end of the contact member comes into contact with a sensor in communication with the alert element for providing an alert to the user.

3. A tension indicator according to claim 2, wherein the sensor comprises an audible spring closely spaced from the contact member.

4. A tension indicator according to claim 2, wherein the sensor comprises an electrical switch in electrical communication with an electronic indicator.

5. A tension indicator according to claim 4, wherein the electronic indicator is a vibration device.

6. A tension indicator according to claim 4, wherein the electronic indicator is a light emitting device.

7. A tension indicator according to claim 4, wherein the electronic indicator is a sound emitting device.

8. A tension indicator according to claim 2, wherein, when the tension on the elongate element is below the predetermined tension, the elongate element is urged by the retention pin into a non-linear configuration, and when the tension on the elongate element is at or above the predetermined tension, the elongate element urges the retention pin to deform the free end of the contact member until the contact member contacts the sensor and provides an alert.

9. In a child safety seat of the type having a harness for restraining a seat occupant that is tension adjustable by means of a tension strap connected to the harness, the improvement comprising a tension indicator for alerting a user when a predetermined tension has been applied to a flexible elongate element, comprising a housing having at least one opening for receiving the elongate element, a tension responsive element positioned in the housing in cooperative engagement with the elongate element and including an actuator mounted in the housing and engaging the elongate element, the tension responsive element being movable in response to an increase in tension on the elongate element from a normally inoperative position into an operative alert position, and an alert element cooperating with the tension responsive element for providing an alert when the tension responsive element is in the operative alert position.

10. In a child safety seat according to claim 9, wherein the actuator comprises a contact member carried by a retention pin attached to the housing and the elongate element is adapted to engage the retention pin and deform a free end of the contact member proportionately to the tension in the elongate element to a point where the free end of the contact member comes into contact with a sensor in communication with the alert element for providing an alert to the user.

11. In a child safety seat according to claim 10, wherein, when the tension on the tension strap is below the predetermined tension, the tension strap is urged by the pin into a non-linear configuration, and when the tension on the tension strap is at or above the predetermined tension, the tension strap urges the pin to deform the free end of the contact member until the contact member contacts a sensor and provides an alert.

12. In a child safety seat according to claim 9, wherein the tension indicator further includes a second opening opposed from the first opening and for receiving the tension strap.

13. In a child safety seat according to claim 9, wherein the tension indicator is positioned on the tension strap and slidable thereon.

14. In a child safety seat according to claim 9, wherein the tension indicator is carried by a safety seat cover.

15. In a child safety seat according to claim 9, wherein the tension indicator is carried by a base portion of the seat.

16. In a child safety seat according to claim 9, wherein the sensor comprises an audible spring closely spaced from the contact member.

17. In a child safety seat according to claim 9, wherein the sensor comprises an electrical switch in electrical communication with an electronic indicator.

18. In a child safety seat according to claim 17, wherein the electronic indicator is a vibration device.

19. In a child safety seat according to claim 17, wherein the electronic indicator is a light emitting device.

20. In a child safety seat according to claim 17, wherein the electronic indicator is a sound emitting device.
